(19) United States
(12) Patent Application Publication
(10) Pub. No.: US 2003/0061718 A1
(43) Pub. Date: Apr. 3, 2003

(54) Blade cartridge holding, releasing, and capturing mechanism for a replaceable cartridge razor

(76) Inventor: Paul R. Dansreau, Shelton, CT (US)

Correspondence Address: PFIZER INC., PATENT DEPARTMENT, MS8260-1611, EASTERN POINT ROAD, GROTON, CT, 06340, US

(21) Appl. No.: 10/263,062

(22) Filed: Oct. 1, 2002

Related U.S. Application Data
(60) Provisional application No. 60/326,766, filed on Oct. 2, 2001.

(51) Int. Cl. B26B 21/52

(52) U.S. Cl. 30/532; 30/527

(57) ABSTRACT

In a shaving razor system including a handle part and a replaceable blade cartridge, the handle part has a cartridge holding, releasing and capturing mechanism including two levers pivotally supported on the handle part, cartridge holding features on the outer ends of two arms of the two levers, and a spring and cam means for moving the two levers in unison to bring the holding features of the levers into and out of holding relationship with complementary holding features of the cartridge with the mechanism being lockable in both the cartridge holding and cartridge release/capture positions.

### BACKGROUND OF THE INVENTION

This invention relates to shaving razors of the type using replaceable blade cartridges each consisting of a body holding one or more shaving blades, with the cartridge being held by a handle part of the razor during a shaving operation and with the cartridge being releasable from the handle part to allow a cartridge held by the handle part to be exchanged for a fresh cartridge when the blade or blades of the first cartridge become dulled or the first cartridge becomes otherwise worn to an undesirable condition; and deals more particularly with a mechanism carried by the handle part of such a razor for holding a blade cartridge to the handle part, for releasing the current cartridge from the handle part when use of the current cartridge is no longer wanted, and for thereafter capturing a new cartridge and holding it on the handle part for subsequent shaving operations.

### FIELD OF THE INVENTION

The construction and use of razor or shaving systems comprising a handle part and a supply of identical blade cartridges which are sequentially attachable one at a time to the handle part to allow repeated replacement of a worn blade cartridge by a fresh blade cartridge are well known in the art; and it is also well known in the art to provide the handle part of such a razor or shaving system with a mechanism which allows the exchange of one blade cartridge for another to be accomplished through the use of only a few simple manipulations on the part of the razor user. However, such simply operated mechanisms are usually in themselves relatively complex and made up of multiple springs and other components that make assembly of the mechanism difficult and introduce possibilities for mechanical operational errors due to tolerance buildup and friction between various moving components.

The general object of this invention is, therefore, to provide a blade cartridge holding, releasing and capturing mechanism carried by the handle part of a razor which uses only a small number of components so as to minimize both component and assembly expense and to reduce the total amount of friction which may be built up between the moving parts of the mechanism.

A further object of the invention is to provide a mechanism of the aforegoing character whereby the mechanism acts to automatically lock itself in both a cartridge holding condition and a cartridge release/capture condition and which can be unlocked from the cartridge holding condition by a simple manual sliding of a trigger member on the part of the user and can be unlocked from the release/capture position by simply pushing holding features of the mechanism against the back of a new blade cartridge as part of the procedure for capturing the new cartridge.

A still further object of the invention is to provide a mechanism such as aforesaid which can be easily modified to adapt it for use with different types of cartridges having different types of holding features which mate with complementary holding features of the mechanism.

### SUMMARY OF THE INVENTION

The invention resides in a mechanism to be carried by the handle part of a shaving razor to allow the handle part to hold, release and capture blade cartridges for the purpose of periodically removing one blade cartridge from the handle part and replacing the removed cartridge with a fresh cartridge, wherein the mechanism has two levers pivotally supported on the handle part, each lever has an outer end with a holding feature cooperable with a complementary holding feature of a blade cartridge with the two holding features of the two levers being movable into and out of holding relationship relative to the holding features of the cartridge by pivotal movement of the two levers, a trigger member supported on the handle part for linear sliding movement relative to the handle part, and a cam means between the trigger member and first arms of the two levers, which cam means moves the two first arms about their pivot axes as the trigger member is moved in its linear motion relative to the handle part between a cartridge holding position, at which the cartridge holding features of the levers are in holding cooperation with the holding features of a cartridge, to a cartridge release/capture position at which the holding features of the levers are in a released condition relative to the holding features of one cartridge and also conditioned to start the recapture of a new cartridge.

The invention further resides in there being a main spring member working between the handle part and the trigger member for urging the trigger member to its cartridge holding position so that a manual force needs to be applied to the trigger member to move the trigger member from the cartridge holding position to the cartridge release/capture position, the trigger member thereafter being able to return to the holding position, under the force of the main spring, only after a manually applied force disengages a pin of the trigger from cocking portions of cam slots in the first arms.

The invention still further resides in the cam means of the mechanism being designed so that when the trigger member reaches its release/capture position, the first arms of the levers are able to move to cocked positions, and in a cocking spring means for urging the first arms of the levers to execute such cocking motion and to thereby assume a cocked condition at which they are held by the cam means when the manual force is removed from the trigger member.

The invention still further resides in the two first arms of the two levers overlying one another, and in the cam means comprising a main cam slot in each of the first arms and a single drive pin carried by the trigger member and received in the main cam slot of each of the first arms so that the single drive pin actuates both levers.

Still further the invention resides in the cocking feature of the cam means comprising, for each of the first arms, a cocking notch located at one end of the main cam slot of that arm and communicating with and extending from the main cam slot generally arcuately about the pivot axis of the arm, and in the cocking spring means for each first arm including a spring associated with the first arm for urging that arm in the direction causing its cocking notch onto the drive pin when the trigger member reaches its cartridge release/capture position.

The invention still further resides in the cocking spring means for each first lever comprising a leaf spring carried by the first arm, and preferably of one piece with the first arm, which leaf spring comes into engagement with and is deflected by a stop, carried by the trigger member, as the trigger member moves toward its cartridge release/capture position.

Other features and advantages of the invention will become apparent from the following written description and claims and from the accompanying drawings illustrating the preferred embodiment of the invention.

### BRIEF DESCRIPTION OF THE DRAWNGS

In the drawings:

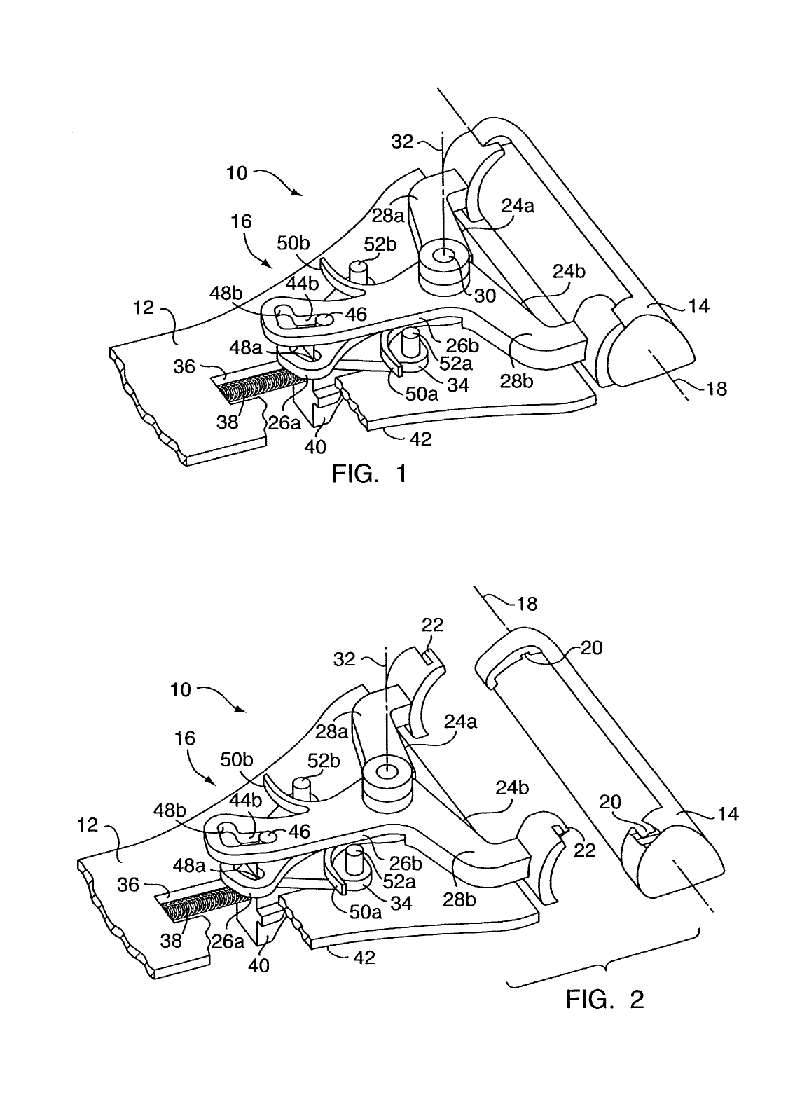

FIG. 1 is a fragmentary isometric view of a shaving razor having a blade cartridge holding, releasing and capturing mechanism embodying the invention, with the view being taken looking generally toward the bottom and one side of the handle part of the razor and with the mechanism being shown in its cartridge holding condition and holding a cartridge.

FIG. 2 is a view similar to FIG. 1 but with the cartridge being shown separate from the handle part to better reveal the holding features of the mechanism and of the blade cartridge, the mechanism itself being shown in the same condition as in FIG. 1.

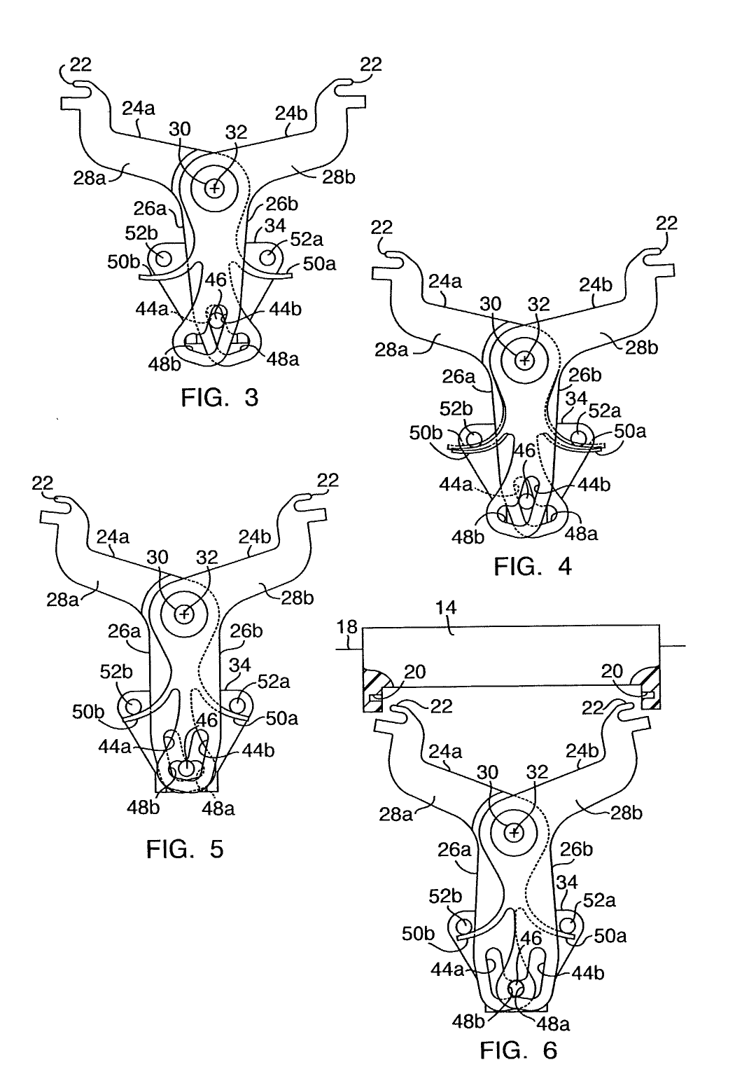

FIG. 3 is a somewhat schematic bottom view of the cartridge holding, releasing and capturing mechanism of FIG. 1 with the trigger member of the mechanism being shown displaced slightly downwardly from the position shown in FIGS. 1 and 2.

FIG. 4 is a view similar to FIG. 3, but with the trigger member being shown displaced somewhat further downwardly in comparison to its FIG. 3 position.

FIG. 5 is a view similar to FIG. 4, but with the trigger member being shown displaced further downwardly than its FIG. 4 position and with the driving pin of the trigger member about to enter the cocking notches of the two first arms of the two levers.

FIG. 6 is a view similar to FIG. 5, but with the two levers of the mechanism being shown in their cocked and locked positions.

### DETAILED DESCRIPTION OF PREFERRED EMBODIMENT

The drawings show the presently preferred and best known embodiment of the invention. Referring to these drawings, and first considering FIGS. 1 and 2, the illustrated razor is indicated generally at 10 and comprises a handle part 12 for use successively with a number of replaceable blade cartridges one of which is shown at 14 in assembly with the handle part 12. Carried by the handle part 12 is a mechanism, indicated generally at 16 which is operable to hold a blade cartridge 14 to the handle part 12 for use during shaving operations and which is also operable to allow the cartridge 14 to be removed from the handle part 12 and to be replaced by a fresh identical cartridge 14 whenever desired by the user.

In both FIGS. 1 and 2, the mechanism 16 is shown in its blade cartridge holding position. The cartridge 14 has a longitudinal axis 18 and has two holding features spaced from one another along the axis 18 which are cooperable with complementary holding features of the mechanism 16. These holding features of the cartridge 14 and of the mechanism 16 are so designed that the holding features of the mechanism 16 can be moved into and out of holding relationship with the holding features of the cartridge 17 by movement of the holding features of the mechanism 16 toward and away from one another along a line generally parallel to the cartridge axis 18. The particular shape and arrangement of the holding features on the cartridge 14 and of the holding features on the mechanism 16 may vary widely without departing from the invention. Also, the mechanism and the cartridge may be designed so that the holding features of the mechanism may move toward one another or apart from one another to reach their cartridge holding positions. In the illustrated example of FIGS. 1 and 2, however, each of the two holding features on the cartridge 14 is a recess 20 located at a respective one end of the cartridge 14 and having a mouth facing the opposite end of the cartridge; each of the two complementary holding features on the mechanism 16 is a finger or flange 22 having a free end facing away from the opposite finger or flange 22; and the fingers 22 move apart from one another to reach their cartridge holding positions. When the mechanism 16 is in its holding condition with a cartridge place, the two holding fingers 22 are received in the holding recesses 20 of the cartridge 14 to hold the cartridge 14 to the mechanism 16 and, as explained hereinafter, from the positions shown in FIGS. 1 and 2, the two holding fingers 22 of the mechanism 16 are movable toward one another to remove them from the cartridge recesses 20 and to thereby release the cartridge 14 from the mechanism 16.

As shown in FIGS. 1 and 2, the mechanism 16 includes two levers 24a and 24b, each having a first arm 26a or 26b, respectively, and a second arm 28a or 28b, respectively. Each of the levers 24a and 24b is supported for pivotal movement about a pivot axis fixed relative to the handle part 12, and in the illustrated and preferred case, such pivotal support for the two levers 24a and 24b is provided by a single pivot pin 30 fixed to the handle part 12 and passing through and supporting the two levers 24a and 24b so that the two levers are each pivotal about the axis 32 of the pin as a common pivot axis.

Assuming the mechanism 16 to be positioned for descriptive purposes as shown in FIGS. 3, 4, 5 and 6, the two first arms 26a and 26b extend generally vertically downwardly from the pivot pin 30 and overlie one another with the arm 26b being in front of the arm 26a as seen in FIGS. 3, 4, 5 and 6.

Referring again to FIGS. 1 and 2, the mechanism 16 includes a trigger member 34 supported by the handle part 12 for linear sliding movement toward and away from the pivot pin 30, or vertically as seen in FIGS. 3, 4, 5 and 6, with the trigger member 34 having a portion received in and guided by an elongated slot 36 in the handle part. The trigger member 34 is movable vertically (as seen in FIGS. 3, 4, 5 and 6) between a holding position, corresponding to the holding fingers 22 of the mechanism being in their holding positions relative to a cartridge 14, and a release/capture position corresponding to the holding fingers of the mechanism 16 being positioned so as to release the previously held cartridge and to be ready to capture a new cartridge when that new cartridge moved toward the pivot pin 30 and into engagement with the holding fingers 22. FIGS. 1 and 2 show the trigger member 34 in its holding position and from this illustrated position of FIGS. 1 and 2, the trigger member 34 is movable downwardly or away from the pivot pin 30 to its cartridge release/capture position. A main compression spring 38 is arranged to work between the handle part 12 and the trigger member 34 to bias the trigger member toward its cartridge holding position and to resiliently resist its movement toward the cartridge release/capture position. The trigger member 34 includes a manually engageable part 40 in the form of a knob-like protrusion extending from the upper surface 42 of the handle part to allow a user to exert thumb or finger pressure onto the trigger member 30 to move it from the cartridge holding position to the cartridge release/capture position against the force of the main spring 38.

The mechanism 16 includes a cam means between the trigger member 34 and the two first arms 26a and 26b for pivotally moving the two levers in unison about the pivot axis 32 in opposite directions as the trigger member moves from its cartridge holding position to its cartridge release/capture position and to move the two first arms in reverse opposite directions as the trigger member 34 moves from its cartridge release/capture position to its cartridge holding position, the cam means also including means for enabling and causing the two first arms 26a and 26b to move to cocked positions relative to the trigger member when the trigger member reaches the cartridge release/capture position, at which cocked positions the two first arms 26a and 26b are held in place by the springs 50a and 50b, when the manual force applied to the trigger member 34 is released. In these cocked positions of the first arms 26a and 26b the two holding fingers 22 of the mechanism are positioned close enough to one another to release one cartridge from the handle part and to prepare the mechanism for capturing another cartridge.

As seen in FIGS. 1 and 2, the cam means between the trigger member 34 and the two first arms 26a and 26b includes a main cam slot 44aor 44b, respectively (best seen in FIG. 6), extending generally vertically in each first arm. The trigger member 34 has fixed to it a drive pin 46 receivable in both of the slots 44aand 44b, Each of the slots 44a and 44b has a width substantially equal to the diameter of the drive pin 46, and the cam slots 44a and 44b are so shaped and arranged on the respective first arms 26a and 26b that as the trigger member 34 moves in one direction or the other, toward or away from the pivot pin 30, the two levers 24a and 24b are rotated uniformly in opposite directions about the pivot pin 30. To provide for the cocking or locking of the two levers when the trigger member 34 reaches the cartridge release/capture position, the cam means further includes a cocking notch (48a or 48b respectively), in each of the first arms 26a and 26b which cocking notch is located at the lower end of the associated main cam slot 43a or 43band which cocking notch 48a or 48b communicates with and extends generally arcuately relative to the axis 32 of the pivot pin 30 so that when the trigger member 34 is in the cartridge release/capture position, the two first arms 26a and 26b can rotate to move the cocking notches 48a and 48b onto the drive pin 46.

To achieve the above-mentioned cocking movement of the first arms 26a and 26b when the trigger member 34 reaches its cartridge release/capture position, a cocking spring means is provided for urging each of the first arms 26a and 26b in the direction required to move its cocking notch 48a or 48b onto the drive pin 46. In the preferred and illustrated case of FIGS. 1 and 2, this cocking spring means for each of the first arms includes a cocking leaf spring, 50a and 50b, respectively, which is engageable with an abutment, in the form of a pin 52a or 52b, respectively, fixed to and carried by the trigger member 34. Preferably and as shown, each of the leaf springs 50a and 50b is formed as one part with the remainder of its associated first arm 26a or 26b. For example, each of the levers 24a and 24b may be made of a ductile molded plastic with the spring member 50a or 50b being a feature formed during the molding process. The two leaf springs 50a and 50b and the two abutment pins 52a and 52b are so shaped and positioned that the pins 52a and 52b are out of engagement with the springs 50a and 50b when the trigger member is in its cartridge holding position and so that the pins 52a and 52b move into engagement with and deflect the springs 50a and 50b as the trigger member 34 moves downwardly toward its cartridge release/capture position, with the forces caused by the deflection of these springs 50a and 50b urging each of the first arms 26a and 26b in such directions as to tend to move the cocking notches 48a and 48b onto the drive pin 46 when the drive pin 46 becomes aligned with the cocking notches 48a and 48b.

The shape of the cam slots can be varied in order to modify the force or distance of trigger movement required to horizontally translate the holding fingers 22, as well as to modify the horizontal distance the holding fingers 22 can move.

Having now described the construction of the mechanism 16, its operation can be summarized by reference to all of the figures. FIG. 1 shows the mechanism 16 with the trigger member 34 in its cartridge holding position at which the two levers 24a and 24b are held by the drive pin 46 of the trigger mechanism at positions where the holding fingers 22 on the outer ends of the second arms 28a and 28b are received in the holding recesses 20 of the cartridge 14 to hold the cartridge to the handle part 12. The two levers 24a and 24b are held essentially locked in this position by the main spring 38 pushing upwardly on the trigger member 34 to position the drive spring 46 at or close to the upper ends of the main cam slots 44a and 44b, Further, the incline of the cam slots 44a and 44b relative to radial lines from the pivot axis 32 is preferably small enough that the drive pin cannot be driven downwardly by forces applied to the outer ends of the second arms 28a and 28b, and therefore the drive pin essentially locks the two levers in their cartridge holding positions and they can be unlocked from such positions only by applying downward thumb or finger pressure to the trigger member knob 40.

FIG. 3 shows the trigger member 34 moved downwardly slightly from its cartridge holding position of FIG. 1. In this position, the movement of the drive pin in the main cam slots 44a and 44b has caused the first lever 24a to be rotated slightly clockwise from its FIG. 1 position and the lever 24b to be rotated slightly counterclockwise from its FIG. 1 position. In this position of the trigger member 34, the abutment pins 52a and 52b have not yet contacted the cocking springs 50a and 50b.

FIG. 4 shows the trigger member 34 positioned somewhat downwardly from its FIG. 3 position. In this FIG. 4 position of the trigger member 34, the first lever 24a has been rotated slightly more clockwise from its FIG. 3 position, the lever 24b has been rotated slightly more counterclockwise from its FIG. 3 position, and the abutment pins 52a and 52b have contacted the cocking springs 50a and 50b to deflect them slightly from their unstressed positions shown by the broken lines at 50a and 50b.

In FIG. 5, the trigger member 34 is shown to be moved downwardly from its FIG. 4 position to its cartridge release/capture position with the drive pin 46 having reached the vicinity of the cocking notches 48a and 48b. In this position of the trigger member 34, the abutment pins 52a and 52b have still further deflected the cocking springs 50a and 50b to exert relatively strong biasing forces on the arms 26a and 26b tending to rotate the arm 24a clockwise and the arm 24b counterclockwise.

FIG. 6 shows the trigger member 34 in the same cartridge release/capture position as FIG. 5 but with the arms 26a and 26b being shown to have been moved by the forces applied on them by the cocking springs 50a and 50b, to bring the cocking notches 48a and 48b onto the drive pin 46.

It should be understood from comparison of FIGS. 1, 3, 4 and 5 that during movement of the drive pin 46 from the tops to the bottoms of the main cam slots 44a and 44b, the two levers 24a and 24b are pivoted only slightly so that the two holding fingers 22 of the mechanism 16 move only a small distance toward one another and possibly not far enough to bring them fully out of the holding recesses of the blade cartridge 14. However, in comparing FIGS. 5 and 6, it will be noted that in movement of the levers 24a and 24b from their FIG. 5 positions to their FIG. 6 positions, the two levers 24a and 24b move substantial distances to shift the two holding fingers 22 much closer to one another so as, in FIG. 6, to be completely removed from the holding recesses 20 of the cartridge 14, thereby allowing the used cartridge to drop from or to otherwise be removed from the handle part 12.

It will also be understood from FIG. 6 that with the levers 24a and 24b in the illustrated positions the drive pin 46 holds the two levers in a locked or cocked condition, and that the two levers can be removed from this cocked condition doing nothing more than moving the two holding fingers 22 against a new cartridge to be captured by the mechanism 16. That is, as the holding mechanism 16, as seen in FIG. 6, is moved upwardly toward a new cartridge 14, the fingers 22 or other outer end parts of the lever arms 28a and 28b come into contact with the cartridge 14 and forces become exerted on the lever arms 28a and 28b to rotate the lever 24a counterclockwise and the 24b clockwise. These movements in turn bring the main cam slots 44a and 44b back into alignment with the drive pin 46, and thereafter the upward force exerted on the trigger member 34 by the main spring 38 moves the trigger member 34 upwardly to drive the drive pin 46 to the upper ends of the slots 44a and 44b to the locked holding position of FIG. 1 at which the new cartridge 14 is held in place on the handle part 12 by the holding fingers 22.

1. A blade cartridge holding, releasing and capturing mechanism for a razor handle for use with replaceable blade cartridges each having a longitudinal axis and two cartridge holding features spaced from one another along the longitudinal axis, said mechanism comprising:
a handle part,
two levers carried by the handle part and each having a first generally vertically extending arm with upper and lower ends and a second arm extending from the upper end of the vertical arm,
one of the second arms of the two levers extending generally to the right from the upper end of its associated vertical arm and the other of the second arms of the two levers extending generally to the left from the upper end of its associated vertical arm,
each of the second arms of the two levers having an outer end with a holding feature for cooperation with a respective one of the two holding features of a blade cartridge,
means supporting each of the two levers for movement relative to the handle part about a pivot axis fixed to the handle part,
a trigger member supported for movement vertically relative to the handle part between vertically spaced cartridge holding and cartridge release/capture positions,
a main spring means between the trigger member and the handle part urging the trigger member toward the cartridge holding position,
a manually engageable part on the trigger member to which a manual force can be applied to move the trigger member from the cartridge holding position to the cartridge release/capture position against the force of the main spring,
cooperating cam means on the trigger member and on the first arms of the two levers for moving said first arms in opposite directions about their pivot axes as the trigger member is moved from said cartridge holding position to said cartridge release position and for moving said two first arms in reverse opposite directions about their pivot axes when the trigger member is moved from said cartridge release/capture position to said cartridge holding position,
said cooperating cam means when said trigger member reaches its cartridge release/capture position permitting said two first arms to move to cocked positions, and
cocking spring means between said trigger member and each of the two first arms, which cocking spring means urges the two first arms to said cocked positions when the trigger member reaches the release/capture position, p1 said cooperating cam means being configured so that after said trigger member has been moved to the cartridge release/capture position by a manual force and the first arms have been moved to said cocked position by the cocking spring means, when the manual force applied to move the trigger member to the cartridge release/capture position is thereafter removed the cam means holds the first arms in their cocked positions, and so that when the outer ends of the second arms are subsequently pushed against a cartridge for cartridge capturing purposes, the forces applied to the second arms move the first arms from their cocked positions and allow the main spring means to then drive the trigger member to its cartridge holding position.

2. A blade cartridge holding, releasing and capturing mechanism as defined in claim 1, wherein said two first arms overlie one another, and
said cam means includes a main vertically extending cam slot in each of said first arms and a single drive pin carried by the trigger member and received in the main cam slot of each of the two first arms.

3. A blade cartridge holding, releasing and capturing mechanism as defined in claim 2, wherein:
said cam means further includes for each of said first arms a cocking notch at an end of the main cam slot, which cocking notch communicates with the main cam slot and extends generally arcuately about the pivot axis of the associated lever.

4. A blade cartridge holding, releasing and capturing mechanism as defined in claim 3, wherein:
said means supporting each of the two levers for movement relative to the handle part comprises a single pivot pin carried by the handle part and passing through and supporting both of the levers so that both levers are pivotal relative to the handle part about a common pivot axis.

5. A blade cartridge holding, releasing and capturing mechanism as defined in claim 4, wherein:
said pivot pin passes through each of said two levers at a point between said first and second arms of the lever.

6. A blade cartridge holding, releasing and capturing mechanism as defined in claim 5, wherein:
said cocking spring means for each of said first arms comprises a leaf spring element on the first arm, and an abutment on the trigger member which abutment comes into engagement with the leaf spring element as the trigger member moves from the holding position to the release/capture position and deflects the leaf spring member to cause the leaf spring member to exert a force on the associated first arm urging that first arm toward its cocked position.

7. A blade cartridge holding, releasing and capturing mechanism as defined in claim 6, wherein:
said leaf spring element of each first arm is of one part with the first arm.

8. A blade cartridge holding, releasing and capturing mechanism as defined in claim 1, wherein:
said cocking spring means for each of said first arms comprises a leaf spring element which is of one part with the first arm.
